(19) United States
(12) Patent Application Publication
(10) Pub. No.: US 2007/0276810 A1
(43) Pub. Date: Nov. 29, 2007

(54) Search Engine for Presenting User-Editable Search Listings and Ranking Search Results Based on the Same

(76) Inventor: Joshua Rosen, Bolinas, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/752,271

(22) Filed: May 22, 2007

Related U.S. Application Data
(60) Provisional application No. 60/803,020, filed on May 23, 2006.

(51) Int. Cl. G06F 17/30

(52) U.S. Cl. 707/3

(57) ABSTRACT

A search engine presents search results with user-editable abstracts and ranks search results based on the user-edited abstracts. A graphical user interface is provided to permit users to edit abstracts of search results. This enables owners of web sites and local businesses with local search listings to deliver abstracts of their products and services in their own words and improve the search ranking of their web sites or local search listings by observing abstract composing rules that are optimized to the relevance algorithm that is applied by the search engine.

### CROSS-REFERENCE TO RELATED APPLICATIONS

This application claims the benefit of U.S. Provisional Patent Application Ser. No. 60/803,020, filed May 23, 2006, the entire contents of which are incorporated by reference herein.

### BACKGROUND OF THE INVENTION

1. Field of the Invention

The present invention relates generally to search engines and, more particularly, to search engines that generate search results that have user-editable abstracts and rank the search results based on the user-edited abstracts.

2. Description of the Related Art

Search engines have become popular tools to identify and locate specific information on the Internet. A search engine is a computer program that, when queried for information, retrieves either related information or pointers to the location of related information, or both, by evaluating content stored in its search database.

The search engines provided by Internet search services, such as Yahoo!, Google and MSN, accept a search query and returns search results ranked in accordance with their respective relevance algorithm. These search results are displayed through a graphical user interface (GUI) that includes an editable text field that displays the search query, a listing of search results, and a listing of text advertisements known in the art as sponsored links. A click on any of the search results hyperlinks the user to the web site associated with that search result and a click on any of the sponsored links hyperlinks the user to the web site of the sponsor.

One of the more popular ways to rank search results involves analyzing the location and frequency of keywords on a web page. Another frequently used technique is analyzing how web pages are hyperlinked to each other. A web page gets a ranking boost based on the number of other web pages that are hyperlinked to it. This technique is described in U.S. Pat. No. 6,285,999, the entire contents of which are incorporated by reference herein. Click-through rates of search results are analyzed in some search engines. The general rule is: the higher the click-through rate, the higher the ranking. A search engine known as Alexa tracks a user's actions while browsing and derives the relevance of search results based on the browsing histories of its users.

### SUMMARY OF THE INVENTION

Embodiments of the present invention employ a search engine that present user-editable abstracts of search results and rank search results based on the user-edited abstracts. The present invention provides a graphical user interface (GUI) that permit users to edit abstracts of search results, a computer system that is programmed with a search engine that present user-editable abstracts of search results and rank search results based on the user-edited abstracts, and a method for presenting a user-edited abstract as a search result.

A GUI according to an embodiment of the present invention, includes a first section including a text input field for a search query, and a second section comprising a plurality of subsections, each subsection displaying at least one search result that is responsive to a search query, wherein each one of the subsections includes a hyperlink for accessing a text input field for a user-authored abstract, and the text input field for the user-authored abstract can be accessed and displayed at each one of the subsections independently with respect to the first section and other subsections. The subsections may further include another hyperlink for accessing another text input field for a user-authored advertising message.

A computer system according to an embodiment of the present invention includes a storage unit storing search results that are responsive to a search query, wherein at least one search result includes a user-defined abstract and the other search results include automatically generated abstracts, and a processor programmed to transmit the search results in response to receiving the search query. The ranking of the search results may be determined using a criterion based on exact matches.

The method for presenting a user-edited abstract to be displayed as a search result, according to an embodiment of the present invention, includes the steps of receiving a user-defined abstract for a search listing, determining whether or not the user-defined abstract is to be associated with the search listing, storing the user-defined abstract for the search listing if the user-defined abstract is determined to be associated with the search listing, generating search results in response to a search query, and if the search results include the search listing, transmitting the user-defined abstract to be displayed as one of the search results. In order for a user-defined abstract to be associated with a search listing, the user submitting the user-defined abstract must be authorized to submit abstracts for the web site corresponding to the search listing. A user may be deemed to be authorized if the user has a confirmed e-mail address and the domain for the user's e-mail address matches the domain for the web site.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a networked computer environment in which the present invention may be practiced.

FIG. 1B is a block diagram of an exemplary client computer that is part of the networked computer environment shown in FIG. 1A.

FIG. 2A is a schematic representation of a GUI according to an embodiment of the present invention that displays search listings with hyperlinks for editing the abstracts for the search listings.

FIG. 2B illustrates the GUI of FIG. 2A when one of the hyperlinks for editing the abstracts for the search listings is accessed.

FIG. 2C illustrates the GUI of FIG. 2A when one of the hyperlinks for editing text advertisements is accessed.

FIG. 3A is a schematic representation of an alternative GUI that is displayed when one of the hyperlinks for editing the abstracts for the search listings is accessed.

FIG. 3B is a schematic representation of an alternative GUI that is displayed when one of the hyperlinks for editing text advertisements is accessed.

FIG. 4 illustrates one process for generating the GUI shown schematically in FIG. 2A.

FIG. 5A is a flow diagram that illustrates the steps carried out by a server computer to generate search results according to an embodiment of the present invention.

FIG. 5B is a flow diagram that illustrates the steps carried out by a server computer to rank search results according to an embodiment of the present invention.

FIG. 6 is a flow diagram that illustrates the steps carried out by a server computer to authenticate the user submitting an edited abstract, according to an embodiment of the present invention.

FIGS. 7A and 7B are schematic representations of a GUI according to an embodiment of the present invention that displays local search listings with hyperlinks for editing the abstracts for the local search listings.

FIG. 8A is a schematic representation of a GUI that is displayed when one of the hyperlinks for editing the abstracts for the local search listings is accessed.

FIG. 8B is a schematic representation of a GUI that is displayed when one of the hyperlinks for editing text advertisements associated with a local search listing is accessed.

FIG. 9 is a flow diagram that illustrates the steps carried out by a server computer to generate local search results according to an embodiment of the present invention.

FIG. 10 is a flow diagram that illustrates the steps carried out by a server computer to rank local search results according to an embodiment of the present invention.

### DETAILED DESCRIPTION

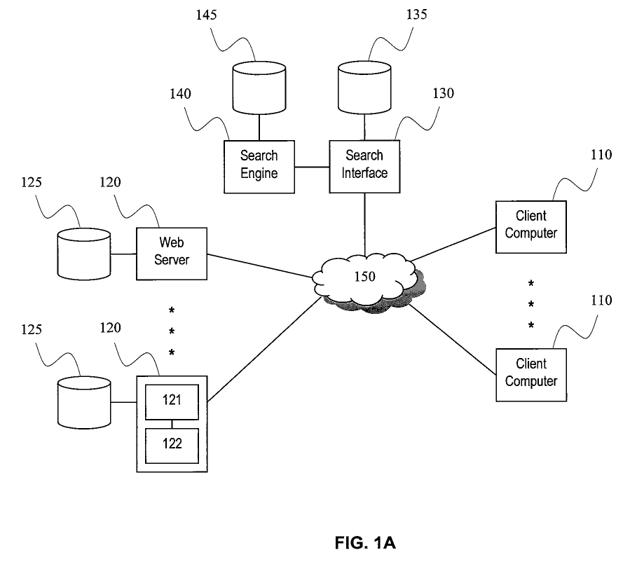

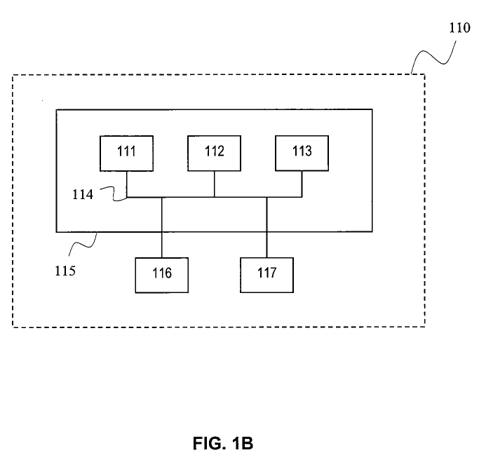

FIG. 1A illustrates a networked computer environment in which the present invention may be practiced. As shown, the networked computer environment includes a plurality of client computers 110 (only two of which are shown), a plurality of web servers 120 with associated content storage units 125 (only two of which are shown), a search interface web server 130 with an associated content storage unit 135, and a search engine web server 140 with an associated content storage unit 145. The client computers 110, the web server computers 120, the search interface web server 130, and the search engine web server 140 are connected over a computer network 150, e.g., the Internet.

The search engine web server 140 may be operated by the same party that is operating the search interface web server 130. In some implementations, the functions of the search interface web server 130 and the search engine web server 140 can be carried out by a single web server. The search engine web server 140 may also be operated by a different party, e.g., an Internet search services provider. As another alternative, the search engine functions may be provided by both the party that is operating the search interface web server 130 and an Internet search services provider.

As illustrated in FIG. 1B, each client computer 110 includes conventional components of a computing device. They include a processor 111, system memory 112 and a hard disk drive 113, that communicate over a bus 114 and are contained within a housing 115, and external devices such as input devices 116, e.g., a mouse and a keyboard, and output devices 117, e.g., a monitor and a printer. Each web server (which may be any of the web servers 120, the search interface web server 130, and the search engine web server 140) includes a processor 121 and a system memory 122, and manages the contents stored in its respective content storage unit using software, e.g., a relational database software. The web server is programmed to communicate with the client computers 110 and other web servers using the TCP/IP protocol. The client computers 110 are programmed to execute web browser programs and access the web pages managed by the web servers by specifying a uniform resource locator (URL) for the web server into the browser.

In the embodiments of the present invention described below, users are respectively operating the client computers 110 that are connected to the search interface web server 130 over the Internet. The web pages that are displayed to a user are transmitted from the search interface web server 130 to that user's client computer 110 and processed by the web browser program stored in that user's client computer 110 for display through the monitor of that user's client computer 110.

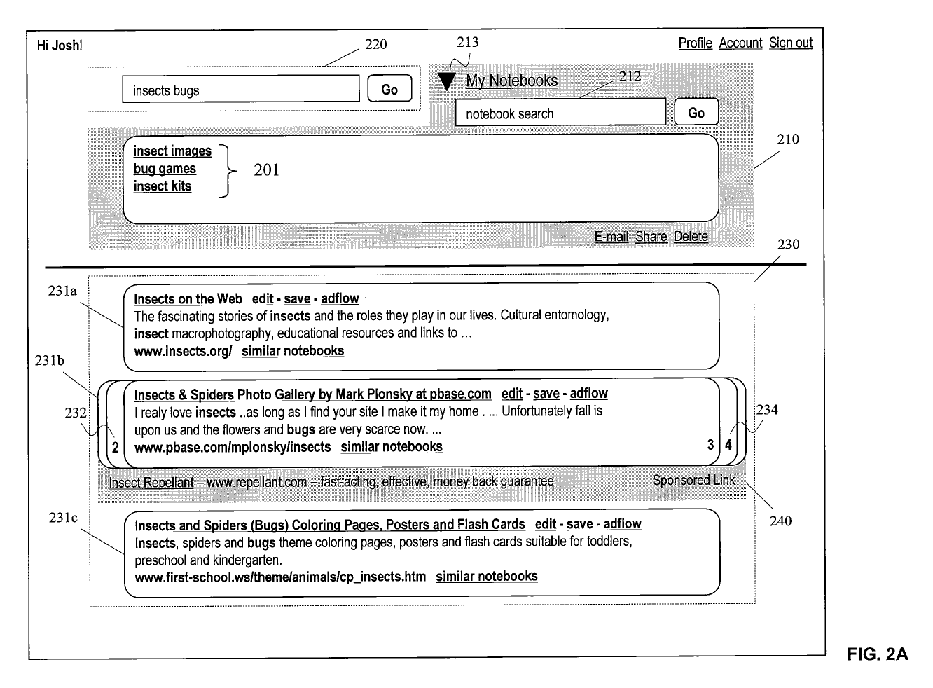

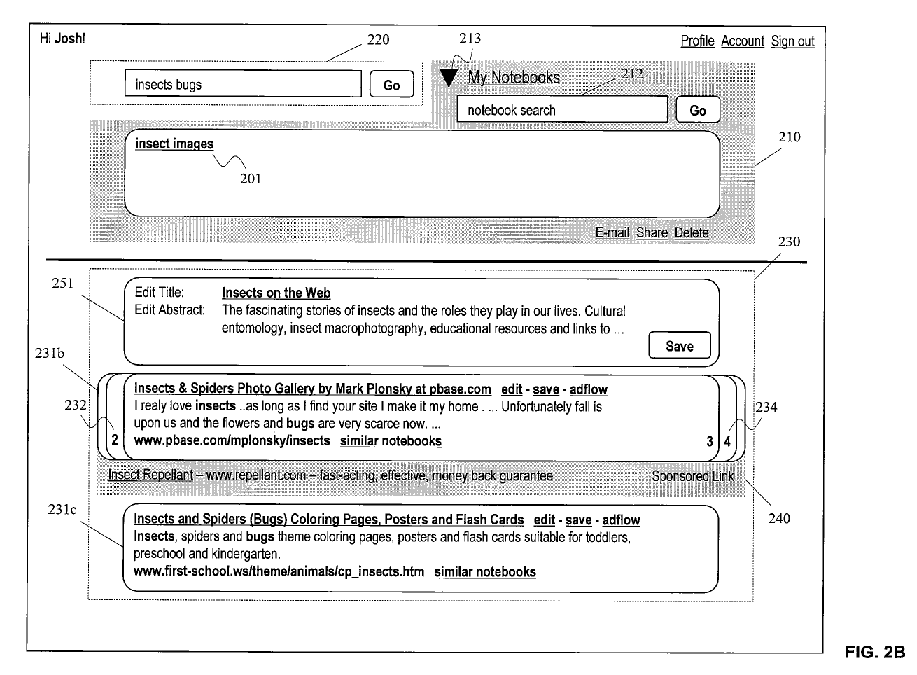

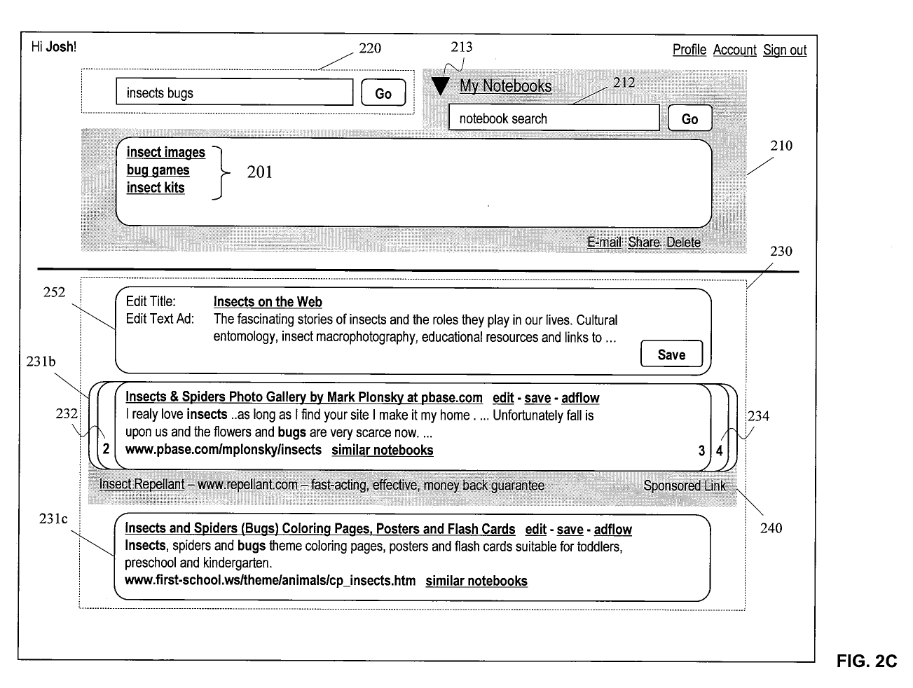

FIG. 2A is a schematic representation of a GUI according to an embodiment of the present invention that displays search listings with hyperlinks for editing the abstracts for the search listings. This GUI is generated by the client computer 110 based on content transmitted by the search interface web server 130. The GUI schematically represented in FIG. 2A has three different sections including a first section 210, a second section 220, and a third section 230. The first section 210 is a section for collecting search results into user-defined groups, referred to herein as “search listing collections” or “notebooks” and managing the notebooks. A list 201 of three such notebooks is shown in FIG. 2A inside the first section 210. A notebook may be shared with another user using the E-mail hyperlink or by specifying viewing and editing privileges for the other users using the Share hyperlink. A user who has viewing privileges to a notebook may import the notebook into his or her personal collection of notebooks. The first section 210 can be collapsed (or expanded after it has been collapsed) by clicking on the arrow 213. The drop region of the first section 210, identified with a darker background in FIG. 2A, is active in either the expanded state or the collapsed state, so that search results can be added to a notebook by selecting them, dragging them to this region and then dropping them in this region. The second section 220 is a section for inputting a search query. The third section 230 is a section for displaying search results 231 that are responsive to the search query, and text advertisements (e.g., sponsored link 240) that are responsive to the search query. In the embodiment of the GUI shown in FIG. 2A, a text advertisement appears directly underneath each notebook, such as under search result 231b.

Each search result 231 provides an abstract of, and a hyperlink to, the web site with which it is associated, and several additional hyperlinks, including “edit,” “save,” and “similar notebooks.” The “edit” hyperlink allows the owner of the web site to edit the abstract of his or her web site. The edited abstract is stored by the search interface web server 130, so that the next time such web site is included in a search result, the edited abstract is displayed to the user. The “save” hyperlink allows the user to save a search result into a notebook. If the user clicks on the “save” hyperlink from the displayed page of a notebook (such as search result 231b), the user is prompted to choose between “save the entire notebook” and “save this page from the notebook.” If the user clicks on the “save” hyperlink from an individual search listing, the individual search listing is stored in the notebook that is currently open in the first section 210. If no notebook is currently open in the first section 210, the user is prompted for a name of a new notebook or an existing notebook into which the individual search listing will be added. The “adflow” hyperlink allows the owner of the web site to create a text advertisement of his or her web site that can be used as a text advertisement appearing in pay-per-click search services like Google Adwords or Overture. The “similar notebooks” hyperlink of a search result causes to be displayed a pop-up menu of notebooks that are most relevant to the search result, when a user clicks on or positions a cursor of a pointing device on top of this hyperlink. A selection of one of the notebooks causes that notebook to be displayed in the display section for the search result in place of the search result.

Each of the three sections 210, 220, 230 comprises at least one inline frame. The first section 210 comprises one inline frame. The second section 220 comprises one inline frame. The third section 230 comprises multiple inline frames. Each search result 231 in the third section 230 is displayed in a separate inline frame, and each sponsored link 240 in the third section 230 is displayed in a separate inline frame. Some search results, such as search result 231b, may comprise notebooks. For these, the pages from the notebooks are displayed one at a time. Other pages of the notebooks can be accessed by clicking on a GUI control for the previous page number (e.g., GUI control 232) or the next page number (e.g., GUI control 234). The page number of the current page is also displayed.

A GUI having inline frames permits any one of the inline frame to be updated with new content without disrupting the rest of the GUI. For example, when a user clicks on the GUI controls 232, 233 appearing in the inline frame corresponding to search result 231b, the display contents of this inline frame are updated without disrupting the rest of the GUI. Also, when the user clicks on the “edit” hyperlink or the “adflow” hyperlink of any of the search results 231, a text input window opens up in the inline frame associated with the search result without disrupting the rest of the GUI. FIG. 2B illustrates the GUI of FIG. 2A when the “edit” hyperlink of the search result 231a is accessed. In response thereto, a text input window for editing the abstract of search result 231a opens up in the inline frame associated with search result 231a without disrupting the rest of the GUI. FIG. 2C illustrates the GUI of FIG. 2A when the “adflow” hyperlink of the search result 231a is accessed. In response thereto, a text input window for editing the text advertisement of search result 231a opens up in the inline frame associated with search result 231a without disrupting the rest of the GUI. After the user completes his or her edits and clicks on the “Save” button, the edited content is transmitted to the search interface web server 130, which stores the edited content in its content storage unit 135.

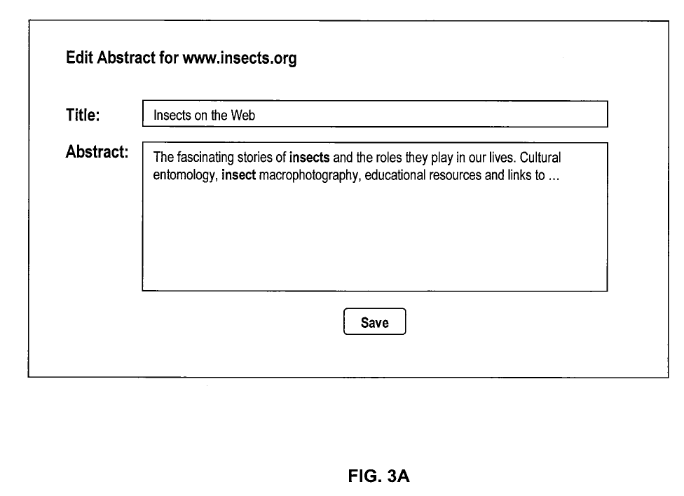

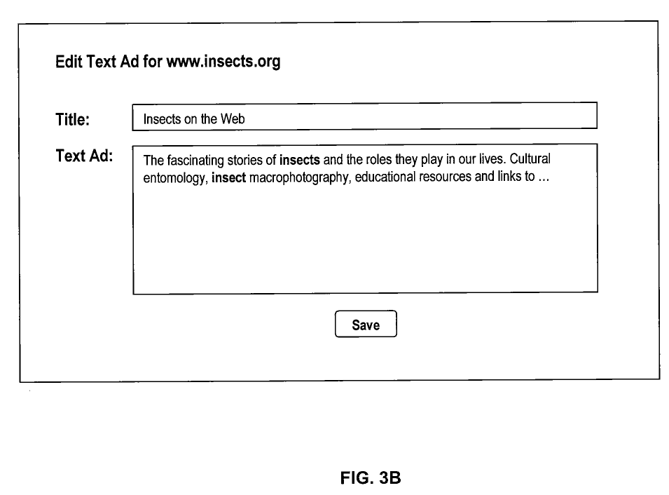

In alternative embodiments of the present invention, the text input window for editing an abstract of a search result or a text advertisement may be provided as a pop-up window. FIG. 3A illustrates the pop-up window for editing an abstract that is displayed when the “edit” hyperlink of the search result 231a is accessed. FIG. 3B illustrates the pop-up window for editing a text advertisement that is displayed when the “adflow” hyperlink of the search result 231a is accessed.

The ability to edit abstracts is of great value to owners or operators of web sites. First, the simple GUI allows owners and operators who are not computer savvy to customize the abstracts. Thus, they are able to deliver abstracts of their web sites in their own words and need not rely on a computer to generate abstracts that are often inaccurate. Second, the owners and operators of web sites can improve the search ranking of their web sites by observing abstract composing rules that are optimized to the relevance algorithm that is applied by the search engine. For example, if the search engine employs an exact match relevance algorithm, one of the abstract composing rules that need to be observed may be: “Always use affirmative tense.” As a consequence, a fee may be collected from web site owners and operators prior to permitting them to edit their web site abstracts.

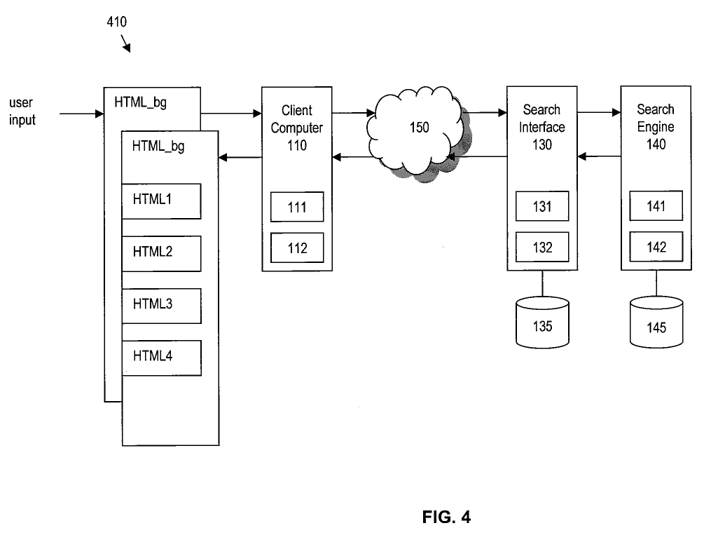

FIG. 4 illustrates one process for generating the GUI shown schematically in FIG. 2A. In the process illustrated in FIG. 4, the display contents for GUI 410, exclusive of the search results, are represented as HTML_bg, and the display contents of each of the search results provided in an inline frame are represented as HTMLn. The user input is represented as user_input. The components of the client computer 110 shown in FIG. 4 include a processor 111 and a memory unit 112. A web browser program is stored in the memory unit 112 and executed by the processor 111 to manage the interactions between it and the search interface web server 130 over the Internet 150. The components of the search interface web server 130 shown in FIG. 4 include a processor 131 and a memory unit 132. A web server program is stored in the memory unit 132 and executed by the processor 131 to manage the interactions between it and the client computer 110 over the Internet 150. The memory unit 132 also stores a program executable by the processor 131 for interacting with the search engine web server 140, e.g., transmitting a search request and receiving search results in response thereto. The components of the search engine web server 140 shown in FIG. 4 include a processor 141 and a memory unit 142. A search engine program is stored in the memory unit 142 and executed by the processor 141 to carry out searches requested by the search interface web server 130.

FIG. 4 illustrates a GUI 410 at two different points in time. Initially, the GUI 410 has no search results displayed. Then, the user submits a search request, represented as user_input, through the GUI 410. The client computer 110 passes on this search request to the search interface web server 130 over the Internet 150. The search interface web server 130 passes on this search request to the search engine web server 140 and receives search results in response thereto. The search results are initially ranked in accordance with the relevance algorithm used by the search engine web server 140. The search interface web server 130 then re-orders the search results based on the relevance of edited abstracts if any of the search results have edited abstracts stored in its content storage unit 135. The re-ordering of the search results is explained in further detail below. Upon receiving this information, the client computer 110 generates the GUI 410 with new display contents for HTML bg, and the search results displayed in separate inline frames, which are represented in FIG. 4 as HTML1, HTML2, HTML3, and HTML4.

In the implementation where the functions of the search interface web server 130 and the search engine web server 140 are carried out by a single web server, the relevance algorithm of the search engine is modified to account for the relevance of edited abstracts in the manner described herein. In such an implementation, the step of re-ordering the search results may be omitted.

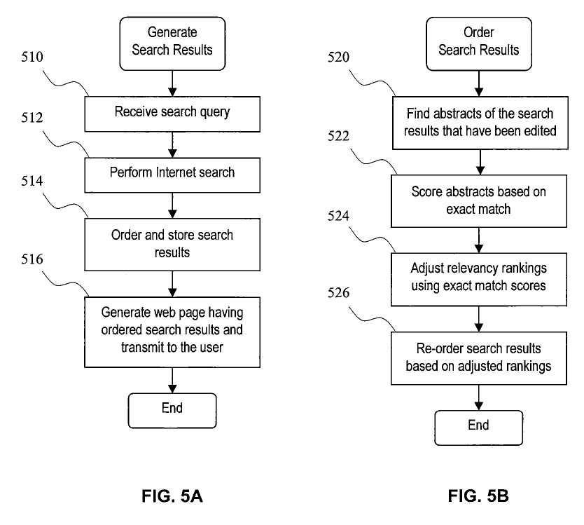

FIG. 5A is a flow diagram that illustrates the steps carried out by the search interface web server 130 to generate search results according to an embodiment of the present invention. In step 510, the search interface web server 130 receives a search query from a client computer 110 over the Internet 150. Then, in step 512, the search interface web server 130 performs the requested search through the search engine web server 140. The search engine web server 140 generates the search results in a particular order and transmits them to the search interface web server 130, which re-orders and stores them (step 514). The search interface web server 130 then generates a web page with the search results that have been re-ordered in step 514 (step 516), and transmits the web page to the client computer 110 over the Internet 150. The client computer 110 then generates a GUI that includes the search results received from the search interface web server 130, such as the one shown schematically in FIG. 2A

FIG. 5B is a flow diagram that illustrates the steps carried out by the search interface web server 130 to re-order search results according to an embodiment of the present invention. In step 520, the search interface web server 130 searches its content storage unit 135 for abstracts of the search results that have been edited. In step 522, the edited abstracts are compared with the search query and scored based on any of the exact match search algorithms known in the art. The scores are used in step 524 to adjust the rankings of the search results. In step 526, the search results are re-ordered based on the adjusted rankings.

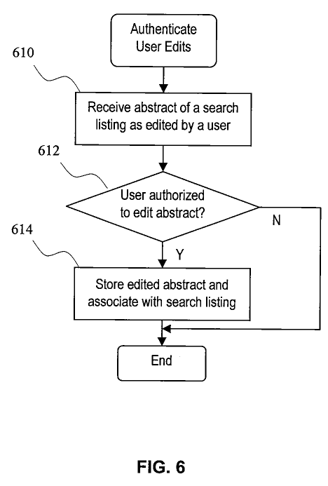

FIG. 6 is a flow diagram that illustrates the steps carried out by the search interface web server 130 to authenticate user edits to an abstract (or a text advertisement). In step 610, the search interface web server 130 receives an edited abstract from a client computer 110 over the Internet 150. Then, in step 612, the search interface web server 130 performs a check to see if the user submitting the edited abstract for a search listing is authorized to edit the abstract for the search listing. If the user is authorized, the edited abstract is stored in the content storage unit 135 and associated with the search listing (step 614). If not, the edited abstract is discarded.

The authorization to edit an abstract may be granted in one of several ways. The first way is to compare the domain of the confirmed e-mail address of the user and the domain of the web site associated with the abstract. If there is a match, authorization is granted. If not, authorization is not given. A second way is to charge a fee for editing the abstract. The authorization is granted to any user who pays the fee based on the assumption that no user would want to pay to edit an abstract of a web site unless the user is, or an agent of, the web site owner or operator. A third way is an off-line authentication method. A user is authenticated off-line through conventional means as one who has authority to make changes to particular web sites, and that information is stored in the search interface web server 130 so that any edits to the abstracts of these web sites submitted by such a user will be authorized by the search interface web server 130.

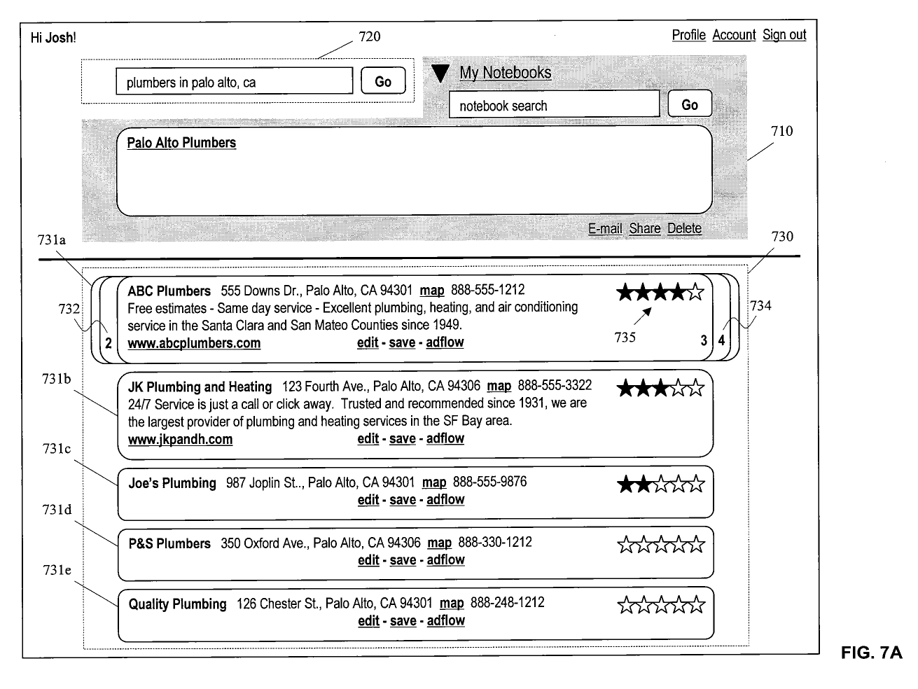

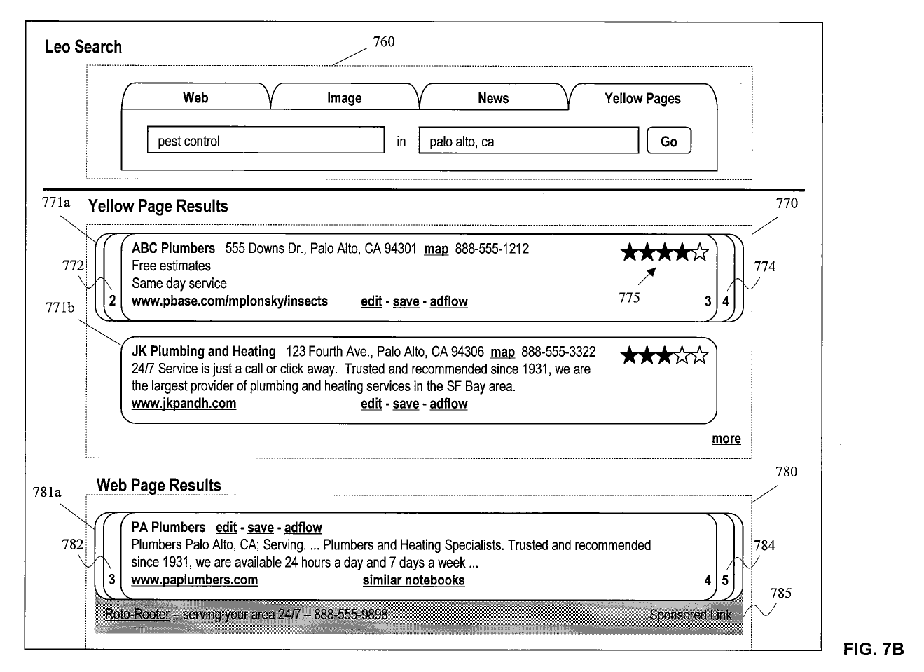

FIGS. 7A and 7B are schematic representations of a GUI according to an embodiment of the present invention that displays local search listings with hyperlinks for editing the abstracts for the local search listings. In the embodiment illustrated herein, the local search listings are listings that are found in an online yellow pages (YP) directory. The GUIs of FIG. 7A and FIG. 7B are generated by the client computer 110 based on content transmitted by the search interface web server 130 in response to a search query submitted from the client computer 110.

The GUI of FIG. 7A has the same features as the GUI of FIG. 2A except that the search results that are displayed are local search results as opposed to web search results. It includes a first section 710 for collecting search results into notebooks and managing them, a second section 720 for entering a search query, and a third section 730 for displaying the search results. The search results displayed in the third section 730 are local search results and include a notebook 731a of local search listings and individual local search listings 731b, 731c, 731d, 731e. The notebook 731a includes GUI controls 732, 734 for scrolling backward or forward through the notebook 731a and a rating I/O section 735. The rating I/O section 735 displays the average of the ratings submitted by users about the business that is featured in the corresponding local search listing and also functions as a section for inputting ratings. The first section 710 comprises one inline frame. The second section 720 comprises one inline frame. The third section 730 comprises an inline frame for each of the local search results 731a, 731b, 731c, 731d, 731e.

The GUI of FIG. 7B is another embodiment of a search interface GUI that is displayed in response to search query that is submitted to a local search engine or a yellow pages search engine. The local search is processed when the “Yellow Pages” tab is selected and a search query is entered in a first section 760, which comprises one inline frame. The search query includes keywords, e.g., “pest control,” and a locality parameter, e.g., “palo alto, ca.” If the locality parameter is missing, the local search engine uses the location information stored in the profile of the user submitting the local search query, if such information is available. Otherwise, the local search engine uses the location of the server computer that is managing the user's access to the Internet.

The search results section includes both a yellow pages results section 770 and a web page results section 780. The yellow pages results include abstracts and contact information of local businesses that meet the search criteria. They may include a notebook 771a of local search listings or an individual local search listing 771b. The notebook 771a includes GUI controls 772, 774 for scrolling backward or forward through the notebook 771a and a rating I/O section 775. The rating I/O section 775 displays the average of the ratings submitted by users about the business that is featured in the corresponding local search listing and also functions as a section for inputting ratings. The yellow pages results section 770 includes an inline frame for each of the search results 771a, 771b.

The web pages results include abstracts of web sites that meet the search criteria. They may include a notebook 781a of search listings or an individual local search listing (not shown). The notebook 781a includes GUI controls 782, 784 for scrolling backward or forward through the notebook 781a. A sponsored link 785 that is responsive to the search query is also displayed. The web pages results section 780 includes an inline frame for each of the search result 781a and the sponsored link 785.

Each local search result 731a, 731b, 731c, 731d, 731e, 771a, 771b provides an abstract of the local business with which it is associated and a hyperlink to an information page that details the products, services and location of the local business. Several additional hyperlinks, including “edit” and “save” are also provided. The “edit” hyperlink allows the owner of the local business to edit the abstract of the local search listing that provides a brief description of his or her business. The edited abstract is stored by the search interface web server 130, so that the next time such business is included in a local search result, the edited abstract is displayed to the user. The “save” hyperlink allows the user to save a search result into a notebook. If the user clicks on the “save” hyperlink from the displayed page of a notebook (such as search result 731a), the user is prompted to choose between “save the entire notebook” and “save this page from the notebook.” If the user clicks on the “save” hyperlink from an individual search listing, the individual search listing is stored in the notebook that is currently open in the first section 710. If no notebook is currently open in the first section 710, the user is prompted for a name of a new notebook or an existing notebook into which the individual search listing will be added. The “adflow” hyperlink allows the owner of the local business to create a text advertisement of his or her local business that can be used as a text advertisement appearing in pay-per-click search services like Google Adwords or Overture.

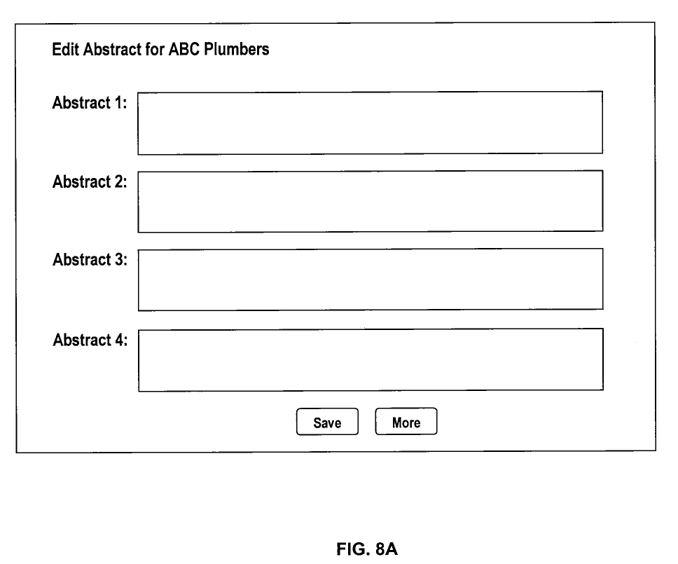

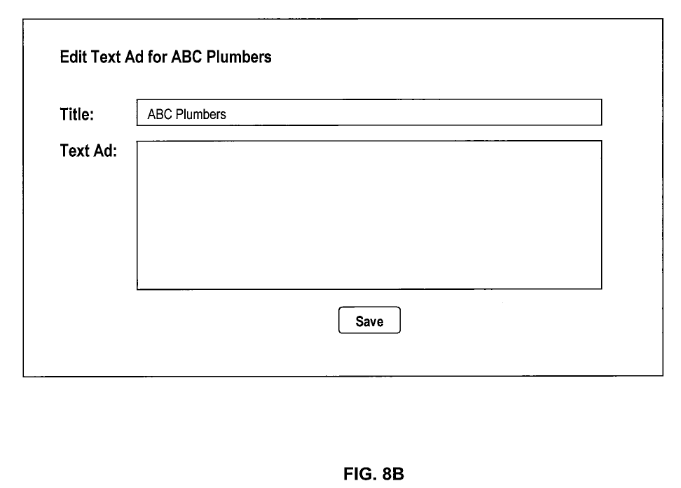

When the “edit” hyperlink displayed on a local search listing is selected by the owner of the local business featured in that local search listing, a text input window for editing the abstract of the local search listing is provided as a pop-up window, such as shown in FIG. 8A. Multiple abstracts may be entered and stored by the owner so that the owner can feature different products and services in different abstracts. When the “adflow” hyperlink displayed on a local search listing is selected by the owner of the local business featured in that local search listing, a text input window for editing a text advertisement for the business is provided as a pop-up window, such as shown in FIG. 8B.

The ability to edit abstracts of search listings is of great value to owners of local businesses. First, the simple GUI allows owners who are not computer savvy to customize the abstracts. Thus, they are able to deliver abstracts of their businesses in their own words and need not rely on a computer or another person to generate abstracts that are often inaccurate. Second, the owners of local businesses can improve the search ranking of their local search listings by observing abstract composing rules that are optimized to the relevance algorithm that is applied by the search engine. For example, if the search engine employs an exact match relevance algorithm, one of the abstract composing rules that need to be observed may be: “Always use affirmative tense.” As a consequence, a fee may be collected from local business owners prior to permitting them to edit the abstracts of their local search listings.

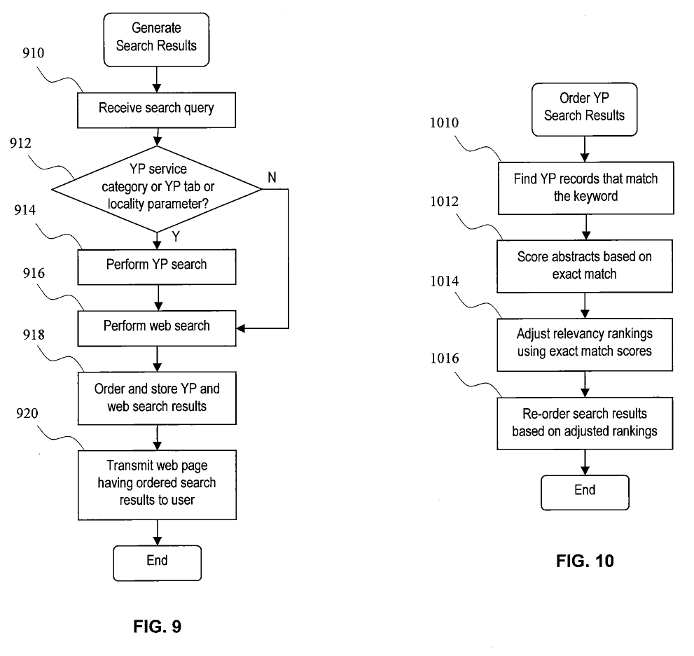

FIG. 9 is a flow diagram that illustrates the steps carried out by a server computer to generate local search results according to an embodiment of the present invention. In step 910, the search interface web server 130 receives a search query from a client computer 110 over the Internet 150. Then, in step 912, the search interface web server 130 determines if a yellow pages service category has been entered as a search query or a yellow pages search engine has been selected or a locality parameter is included in the search query. If any of these conditions are met, the requested search is carried out through the yellow pages search engine (step 914) and then the web search engine (step 916). If none of the conditions are met, step 914 is skipped and step 916 is carried out. In step 918, the search interface web server 130 receives the search results in a particular order, re-orders them and stores them. The search interface web server 130 then generates a web page with the search results that have been re-ordered in step 918 (step 920), and transmits the web page to the client computer 110 over the Internet 150. The client computer 110 then generates a GUI that includes the search results received from the search interface web server 130, such as the one shown schematically in FIG. 7B

FIG. 10 is a flow diagram that illustrates the steps carried out by a server computer to rank local search results according to an embodiment of the present invention. In step 1010, the search interface web server 130 searches its content storage unit 135 for abstracts of the local search results that have been edited. In step 1012, the edited abstracts are compared with the search query and scored based on any of the exact match search algorithms known in the art. The scores are used in step 1014 to adjust the rankings of the local search results. In step 1016, the search results are re-ordered based on the adjusted rankings.

The functionalities of the GUIs described above may be implemented in the web pages using a markup language, scripting languages and associated libraries that provide inline framing, drag and drop, and other dynamic visual effects and user interface elements provided by the Prototype JavaScript Framework via the Document Object Model. The library that is employed in the embodiments described above is known as “scriptaculous.”

While particular embodiments according to the invention have been illustrated and described above, those skilled in the art understand that the invention can take a variety of forms and embodiments within the scope of the appended claims.

What is claimed is:

1. A graphical user interface (GUI) generated by a client computing device in communication with a server computing device over a communications network, the GUI comprising:
a first section including a text input field for a search query; and
a second section comprising a plurality of subsections, each subsection displaying at least one search result that is responsive to a search query,
wherein each one of the subsections includes a hyperlink for accessing a text input field for a user-authored abstract, and
wherein the text input field for the user-authored abstract can be accessed and displayed at each one of the subsections independently with respect to the first section and other subsections.

2. The GUI according to claim 1, wherein each one of the subsections further includes another hyperlink for accessing another text input field for a user-authored advertising message.

3. The GUI according to claim 1, wherein a user-authored abstract is displayed as a search listing in at least one of the subsections.

4. The GUI according to claim 3, wherein automatically-generated abstracts are displayed as search listings in the other subsections.

5. The GUI according to claim 1, wherein at least one subsection includes a search listing collection, the search listing collection comprising at least two search listings that are displayed one at a time.

6. A computer system comprising:
a storage unit storing search results that are responsive to a search query, wherein at least one search result includes a user-defined abstract and the other search results include automatically generated abstracts; and
a processor programmed to transmit the search results in response to receiving the search query.

7. The computer system according to claim 6, wherein a first search result includes a user-defined abstract and a second search result includes a user-defined abstract, and the order of the first search result and the second search result appearing in the search results is determined based in part on the content of the user-defined abstracts of the first and second search results.

8. The computer system according to claim 7, wherein the search results are ordered using a criterion based on exact matches.

9. The computer system according to claim 6, wherein the search results includes a search listing collection, the search listing collection comprising at least two search listings that are displayed one at a time.

10. The computer system according to claim 9, wherein the processor is further programmed to transmit the search results as a plurality of inline frames.

11. A method of presenting an abstract to be displayed as a search result, comprising the steps of:
receiving a user-defined abstract for a search listing;
determining whether or not the user-defined abstract is to be associated with the search listing;
storing the user-defined abstract for the search listing if the user-defined abstract is determined to be associated with the search listing;
generating search results in response to a search query; and
if the search results include the search listing, transmitting the user-defined abstract to be displayed as one of the search results.

12. The method according to claim 11, wherein a plurality of user-defined abstracts are stored and respectively associated with a plurality of search listings, and if the search results include any of the plurality of search listings, the corresponding user-defined abstracts are transmitted.

13. The method according to claim 12, further comprising the step of ordering the search results including any of the plurality of search listings based on the content of the corresponding user-defined abstracts.

14. The method according to claim 11, wherein the search listing is associated with a web site and the step of determining includes the step of determining whether the user submitting the user-defined abstract has been authorized to submit abstracts for the web site.

15. The method according to claim 14, wherein the user is deemed to be authorized if the user has a confirmed e-mail address and the domain for the user's e-mail address matches the domain for the web site.

16. The method according to claim 11, wherein the user-defined abstract is associated with the search listing if a payment has been received for associating the user-defined abstract with the search listing.

17. A method of generating search results in response to a search query that includes a locality parameter, comprising the steps of:
searching for records that satisfy the locality parameter;
retrieving information about the records that satisfy the locality parameter; and
displaying the retrieved information in a plurality of subsections, wherein each one of the subsections includes a hyperlink for accessing a text input field for editing the information that is displayed in said subsection.

18. The method according to claim 17, wherein the displayed information about one of the records that satisfy the locality parameter includes an abstract that has been authored through the text input field for said record.

19. The method according to claim 18, wherein the displayed information about another one of the records that satisfy the locality parameter includes the name, address and phone number of a business entity and does not include an abstract.

20. The method according to claim 18, wherein the displayed information about another one of the records that satisfy the locality parameter includes a user rating of the business entity.

21. The method according to claim 17, wherein said records comprise yellow page records, each of which contains at least name, address, and telephone number of a business entity.

22. A method of generating search results in response to a search query that includes a locality parameter, comprising the steps of:
searching for records that satisfy the locality parameter;
retrieving information about the records that satisfy the locality parameter; and
displaying the retrieved information in a plurality of subsections, wherein one of the records that satisfy the locality parameter includes a collection of records, and one of said subsections displays a graphic representing the collection of records and information about one of the records in said collection.

23. The method according to claim 22, wherein the subsection displaying the graphic includes a hyperlink for navigating between the records in said collection to cause information about other records in said collection to be displayed.

24. The method according to claim 23, wherein the content displayed by the subsection displaying the graphic can be updated independently with respect to the other subsections.

25. The method according to claim 24, wherein each of the subsections comprises an inline frame.

26. The method according to claim 22, wherein said collection of records is compiled based on user ratings of businesses represented in the records.
